(19) United States
(12) Patent Application Publication
(10) Pub. No.: US 2011/0307806 A1
(43) Pub. Date: Dec. 15, 2011

(54) MULTIPLE PARTY DECISION PROCESS

(76) Inventors: Matthew Hills, Arlington, VA (US); Cameron Hamilton, Arlington, VA (US)

(21) Appl. No.: 12/815,154

(22) Filed: Jun. 14, 2010

(51) Int. Cl. G06F 3/01

(52) U.S. Cl. 715/753

(57) ABSTRACT

The present invention is directed to a multiple party decision process. The parties include an inquirer and an audience. The inquirer posts a question along with a series of weighted factors statements that are analyzed according to a function. The output of the function is represented in a visual indicator proximate to the weighted factors. The audience may modify factor statements, both existing and potential. Modifications to the quantity or weights of the factor statements may compel a recalculation of the weighted factor statements according to the function with a changed representation of the visual indicator.

### FIELD OF THE INVENTION

The present invention relates to the field of decision-making and more specifically to the field of polled social media interaction.

### BACKGROUND

User generated web content sites allow users to submit data online and share that data with others. There are many forms of user generated content, which serve any number of purposes, from submitting videos and photos, to product reviews, to short messages. Currently, evaluation and decision processes do not effectively exist on the web to define specific subjects, factors, and arguments, and then allow for collaboration with a community. The present invention seeks to fill that gap.

### SUMMARY

The present invention is directed to a multiple party decision process. The parties include an inquirer and an audience. A step of the process includes displaying an electronically-posted two-answer question viewable by the audience selected by the inquirer. The inquirer defines a modifiable factor array of discrete and modifiable factors related to the question. With each factor of the factor array is included a factor statement and a modifiable factor weight displayed in a weight indicator correlated to each factor statement.

The question is depicted along with the factor array to the audience with reference to a visual decision board. The visual decision board includes a first distinct preference portion and a second distinct preference portion and a visual indicator that displays a first decision position. The first decision position is a visual representation of the totality of decision factors decided as a function of the factors as weighted. As the inquirer may not have appropriately considered all factors significant to a decision or correctly weighted existing factor statements, a user may modify the factor array. A modification, depicted to the user via a modification field, includes an addition of a factor, or portion thereof, or an alteration of a component of a preexisting factor. The modification field is preferably manifested in two distinct entry fields, an alteration field and an addition field. The addition field is presented to the audience for posting a proposed addition of a factor to the factor array. An alteration field is presented to the user for a proposed alteration of an existing factor. A comment field is presented to the audience for thoughts that do not have independent capacity to modify the factor array.

The factor array may be modified based on one or more proposed alterations or additions, and if it is, then the visual indicator may be repositioned to a second position with the visual indication board in real time according to the function of the present invention.

Sites that do exist in the social decision making space are focused on information and require that you answer a set of preexisting questions, or define certain factors, and then the site gives you a probable ‘answer’. This ‘black box’ approach differs greatly from the present invention, which is far more flexible and involves direct collaboration and participation with other users. It is formatted to accept most any decision in an either/or format or evaluation (e.g., is something pro/good or con/bad?) that a user can define. Then, other users suggest and collaborate in the decision process to determine an ultimate recommended outcome, with the user having control over all the accepted factors and weights to maximize their utility from the process. This combination of flexibility, collaborative process, and creator control is new to the social decision making space and user-generated content sites.

Furthermore, the present invention goes beyond the social decision making space, into a new realm of “social evaluation”. Due to its flexibility, this invention can be used to evaluate a given subject amongst a set of users, similar to an online poll, review, or feedback forum, but with much more depth and analysis, and without a predefined choice or decision as the end result. Instead of the invention being used for a specific decision (e.g. “should I do x or y?”), it can be used to determine if something is pro or con, or good or bad, to a group of participating users. It then goes even further and shows the factors and arguments as to why a particular determination was reached. In online polls, a user can choose from a set of predefined answers, but they do not have a way to add new ones to the list, nor do they have a way to include their reasons for choosing those answers. This invention provides that ability and thus adds significant value and depth to the social evaluation space.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a view of the process of the present invention.

FIG. 2 is a view of the process of the present invention

FIG. 3A is a view of the system of the present invention.

FIG. 3B is a view of the system of the present invention.

FIG. 4 is a view of the system of the present invention.

FIG. 5 is a view of the system of the present invention.

### DETAILED DESCRIPTION

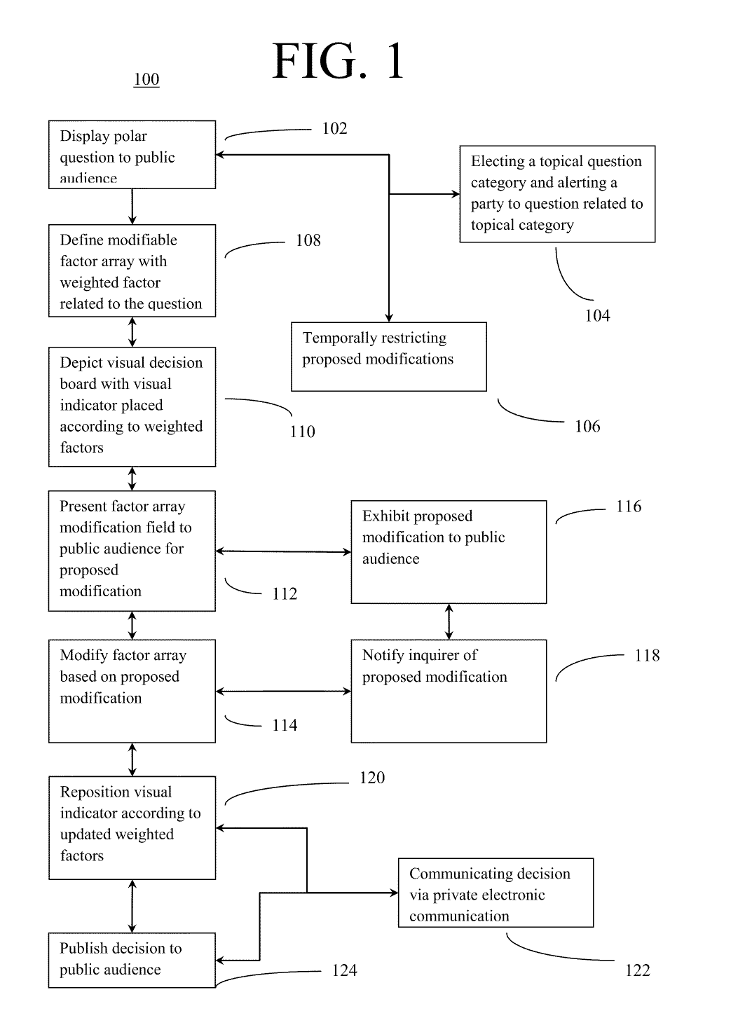

Referring first to FIG. 1, a basic embodiment of the multiple party decision process 100 is shown. An inquirer displays 100 an electronically-posted two-answer question.

Although the present invention applies to questions with answers of more than two possibilities, the preferred format includes questions with only two answers. The two-answer question is often a polar question, i.e. a question answerable only in the form of “yes” or “no.” The inquirer may phrase the question in any manner that compels an answer with two options, and may display the two options to an audience.

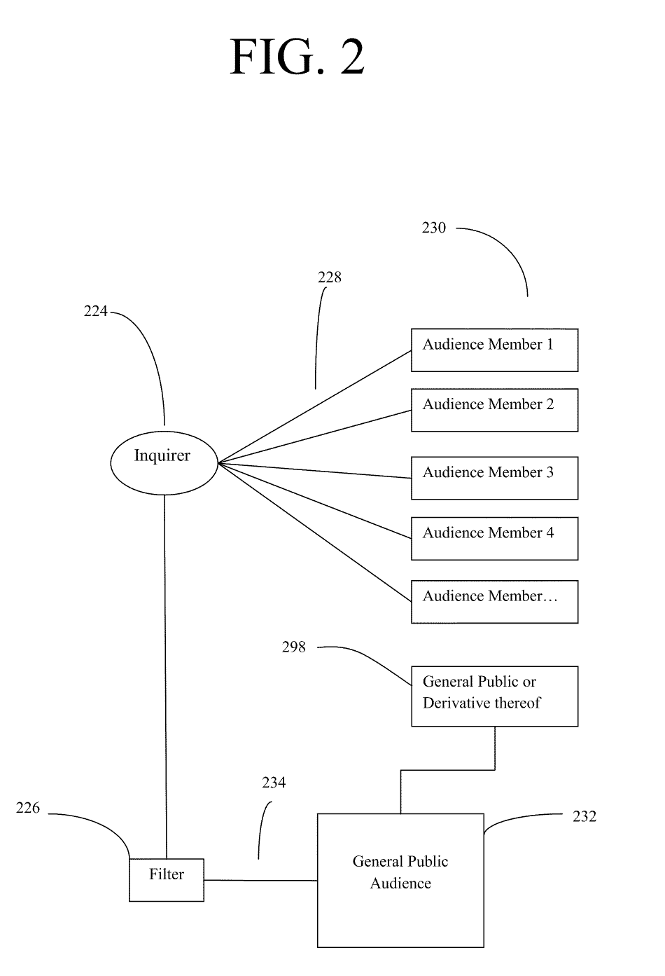

Turning now to FIG. 2, the audience 230, 232, 298 includes all entities capable of responding to the question of the present invention. The audience preferably includes a preselected audience 230, the general public 232, a selection 298 of the general public filtered 234 by characteristics other than individual identities, or some combination thereof. Preselected audience members 230 may be selected from the inquirer's pre-existing contacts, including electronically-stored business contacts, personal contacts, or borrowed contacts (e.g., a list generated by a commercial service). The preselected audience members may be invited by any electronic means, including e-mail, text message, visual notification means, auditory notification means, or any other form of electronic communication suitable to alert an entity as to the existence of the question. The inquirer 224 may elicit feedback from the filtered public audience 298, i.e. a public selected on criteria related to attributes rather than pre-existing knowledge of identity. The attributes may be displayed in a filter 226 and include any pertinent criteria, including describing attributes related to the subject matter of the question (e.g., education, life experience, lifestyle choices, professional experience, etc.), the physical characteristics of the public (e.g., age, race, gender, height, background, etc.), or any other desirable criteria. The inquirer 224 may decide to set the filter to null, which allows all participants to access the question. The access to the question that the inquirer allows depends on the desires of the inquirer, and the inquirer may modify that access to the extent that it desires

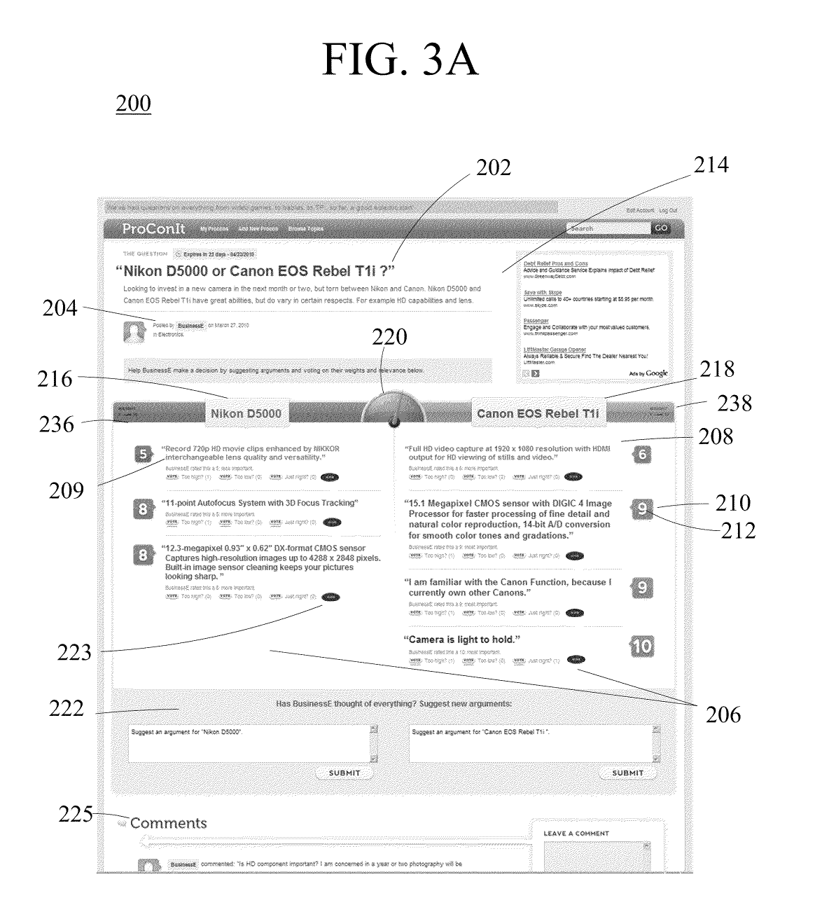

Returning to FIG. 1 and with reference to FIGS. 3A and 3B, access to the question may be simplified by associating 104 the question with a series of question attributes, which preferably includes an election by the inquirer 204 of a topical question category (e.g., lifestyle, automotive, home, garden, etc.). The access to question may be temporally restricted 106 by the inquirer 204 to all audience members or a portion thereof.

The inquirer 204 defines 108 a factor array 206 composed of factors 208 related to the question. The factors 208 are a series of concepts that contain information related to the question 202 and include both a factor statement 209 and a modifiable factor weight 212. The factors 208 have factor statements 209 at least initially defined by the inquirer 204 that include a weight 212 displayed in a weight indicator 210 that correlates to each of the factor statements 209. It is preferred that the factor statements include only a single concept and not comingle thoughts. For example, a factor statement related to a decision to move to the state of Washington should not read: “It rains a lot in the state of Washington and the state's baseball teams infrequently win.” Each concept related to the achievements the baseball teams and the weather should be expressed in separate factor statements for separate factors. Segregation of concepts permits simplified usability and understanding of the decision process.

The inquirer 204 may first disclose the factor array 206 to the audience in a form that include none, one, or more factors 208; and none, one, or more weight indicators 210. It is preferred that the inquirer 204 establish multiple factors 208 of both a first preference 216 and a second preference 218, which for computational purposes may by assigned a positive and negative value corresponding to the weights associated therewith. A preference for purposes of this disclosure means one of the two, and in some cases more, potential answers to a question and the factors indicative of a particular preference. Preferences and preference statements, and the factor statements that relate to such preferences, do not include neutral statements, i.e. statements that do not indicate a positive or contrary (or “negative”) position with respect to the question, or statements that assume both a positive and contrary position. A factor statement with conflicting preferences is preferably not used, although it need not be actively restricted. Factors, including the factor statements therein, that have independent significance to be evaluated, including removal, alteration, addition, etc., are known as “discrete,” while factors with factor statements having only a single concept are known as “single-concept” factors or factor statements.

The inquirer 204 further preferably defines the weight 212 in the weight indicator 210 for each factor statement. The weight 212 includes an alpha-numeric value suitable to indicate to the audience the significance of the factor statement 208. Preferred values for the weight include integers, but other intervals (e.g., decimals and fractions) and characters may suffice, including letters (e.g., A-F), symbols (a series of cartoons with differing expressions of severity), and any other means of communicating severity.

A visual decision board 214 with the question 202 and the factor array 206 is depicted 110 to the audience. The visual decision board 202 includes at least a first preference portion 236 and a second preference portion 238, each distinct from the other. By distinct, it is meant that the factors that related to a particular preference may be spatially distinguished from the factors related to the other, or another, preference to a degree that permits factor statements related to a preference to be grouped in a logical arrangement that establishes the preference without a detailed, focused examination of the board. It is preferred that the factors are bifurcated spatially, with all factors for the first preference occupying one half of the visual decision board and all factors for the second preference positioned in the other half of the visual decision board. Any logical grouping that spatially separates the factors related to a particular preference will suffice. The visual decision board includes screen space in an electronic visual communications device upon which substantially contiguous information related to the question 202 is positioned. Furthermore, the factors may be distinguished by preference by use of a preference identifier, which includes some graphic indication of the preference to which a factor corresponds. A preferred means of preference identification includes use of distinct colors and/or shapes for each preference.

Visually proximate, including on or nearby, to the visual decision board 214 a visual indicator 220 is positioned. The preferred visual indicator is a simple graphic that indicates the currently prevailing opinion of an answer in favor of one preference or other. The visual indicator 220 includes means for graphically depicting a score derived preferably as a function of the quantity and weight 212 of factor statements 208. A preferred function for numerical weights includes:

ΣWeights of First Preference Factors−ΣWeights of Second Preference Factors=Result Equation 1.

The resulting value is used to alter the visual indicator 220 to a representation correlating to the resulting value. When used with the Equation 1, a positive result would correlate to a visual indicator that indicated that the first preference is the current prevailing opinion, and vice versa. The visual indicator may include a representation of positive, negative, and/or neutral (in the event of an offsetting resulting value). Preferred visual indicators include a hinged meter with a needle that points toward the first preference portion 236, toward the second preference portion 238, or in between the first preference portion and second preference portion. It is preferred that the visual indicator include at least one interior coloration representative of the contemporaneous value that results from the function. Alternate forms of visual indicator may include a stoplight with a representation of green, yellow, and red lights related to the contemporaneous value that results from the function; a scale with plates leaning toward the first preference portion, leaning toward the second preference portion, or are balanced; a sliding scale with a needle that is positioned in the first preference portion, positioned in the first preference portion, or is positioned in between the first preference portion and second preference portion. The visual indicator need not include a position that correlates to the first preference portion or second preference portion of the visual decision board; the visual indicator may relay purely on its own representations, e.g. internal colorations, to represent a positive, negative, or neutral result from the function, particularly in the case of yes/no questions.

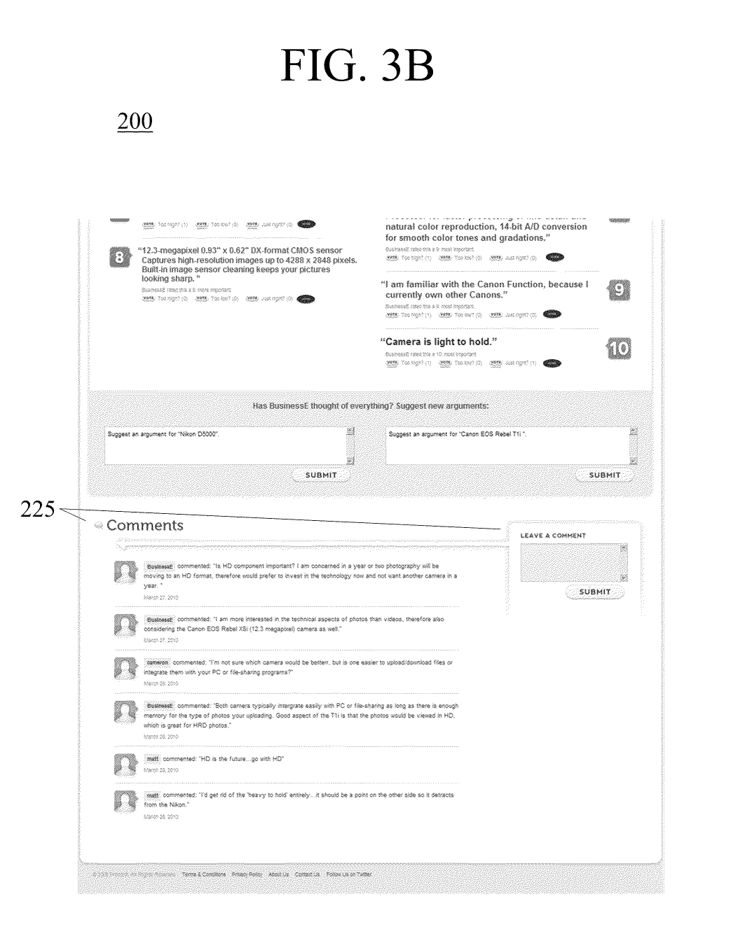

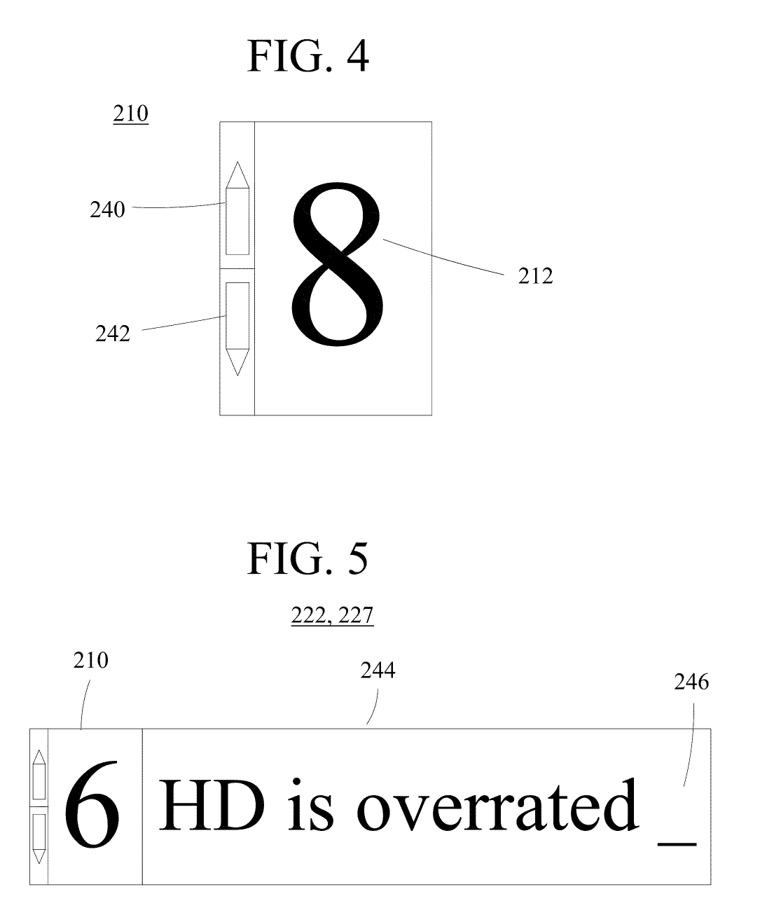

A factor array modification field is presented 112 to the audience for posting a proposed factor 208 addition to or proposed factor alteration of the factor array 206. The factor array modification field may consist of a single entity, or may be composed of multiple subparts. It is preferred that the factor array modification field includes at least two subparts, including a factor array addition field 222 and a factor array alteration field 223. The factor array addition field 222 is presented to the audience for posting a proposed factor 208 addition to the factor array 206. The factor additions preferably include a new factor statement 209 coupled with a factor weight 212. As FIGS. 4-5 show, alterations to the existing factor weights 212 may be made via a factor array alteration field including a weight indicator 210 having a preformed modification adjustors 240, 242 corresponding to a factor weight adjustment increase and a weight adjustment decrease of the factor weight 212. Alterations to existing factor statements may be made via a factor array alteration field 223 that includes factor statement field 244 with an editing cursor 246. The preferred factor array alteration field shown in FIG. 5 shares structural attributes with the preferred factor array addition field 227—and the means of proposing modifications thereby may be substantially identical. The preferred factor addition field 227 includes a weight modifier 210, which may be initially set at a particular weight or null, and a factor statement field 244, which may be set to an example statement exemplifying the preferred single concept attributes of the preferred factor statement or set to null. The factor modification field permits an audience member to add or alter a proposed factor, which may be reposted to the factor array 206 at the discretion of the inquirer. Furthermore, any proposed weight, whether modified or added, proffered by an audience member may be included in the factor array 206 at the discretion of the inquirer.

Returning to FIG. 1 and FIGS. 3A and 3B, the factor array 206 may be modified 114 based on a proposed modification, which can include either a factor array addition or factor array alteration. That is to say, that an audience member may submit proposed modification data—which may include a proposed statement, weight, or adjustment thereof—and then transmits 118 the proposed factor array alteration to the inquirer. The inquirer reviews the proposed modification and may update the factor array based upon the proposed modification to the factor array, which posts the alteration/addition to the board 214. Alternatively, the inquirer may discard the proposed modification, which will not affect the existing factor array or any indications of preference. Furthermore, the proposed alteration may be displayed prior to inclusion within the factor array 206, in a comment field 225, or via inquirer actuated means. Inquirer actuated means may include a designated display area, e-mail, text message, or other form of visual presentation. Modifications to the factor array need not originate from the audience; the inquirer, as an afterthought, may desire to update the factor array 206 through a factor array modification, proposed or directly entered with further comment from the audience. The factor array alteration may originate from the comment field 225 passively, however, the primary purpose of the comment field is to provide mere comment on the factors and proposed additions. The comment field 225 is preferably without mechanism for directly submitting a suggestion or modification to the factor array.

Upon inclusion of a proposed alteration to the factor array 206, the factor array is updated. The visual indicator 220 is updated 120 according to the contemporaneous weighted factor statements according to the function of the present invention. It is preferred that the visual indicator 220 update after each factor addition or alteration is accepted/posted by the inquirer.

The inquirer may accept proposed alterations to the extent that it desires. That is to say, the inquirer may accept portions of the factor as submitted and reject other portions. The inquirer may alter the proposed factor statement or factor weight. Modifications may be shunted to an intermediary page where ‘accept’, ‘decline,’ and ‘alter’ actions are posted with the proposed factor array modification and the inquirer can click those to proceed. Alternatively, there may be a ‘response’ page for each question where the modifications can be accepted, rejected, or altered. Thus, the inclusion of a modification may be adjudged by the inquirer, or the audience, or some portion thereof, may vote upon the suitability of the modification. When satisfied with the analysis of the question, the inquirer may discontinue further proposed modifications and issue a final result based on the function or other means. The final result may be published 124 to the audience by posting the final result in an accessible forum, and/or the final result may be communicated 122 via private electronic communication, e.g. email, text message, etc.

The audience may be alerted to particular questions posed according to the present invention by multiple means. Preferred means include private electronic communication alerts as well as electronic browsing simplification routines. A further preferred means of alert includes an audience member actively describing its attributes and selecting a notification based upon its described attributes.

Additional attributes of the present invention may vary with the means for which it is used. The inquirer may give out reputation points to audience members that are helpful. The inquirer can create a personal set or label for its question, e.g. to be part of a group. Inquirer can indicate a ‘gut’ instinct for which choice they think is correct, then compare the gut instinct with the analysis. The audience can vote to indicate if a question, overall, is valuable, or thumbs up/thumbs down, and would be used to promote and order questions on a main page cataloging questions. The present invention may be utilized with a favor system, in which each time a user votes or suggests a factor, s/he is awarded favor points, which will indicate later if the user owe someone or someone owes him/her for assistance.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A multiple party electronic decision process comprising:
displaying an electronically-posted two-answer question having a first preference and a second preference and viewable by an audience, predetermined in scope by said inquirer, electronically accessing said question;
defining through said inquirer a modifiable factor array composed of modifiable factors having discrete factor statements related to said question and a modifiable weight, displayed in a weight indicator, corresponding to each discrete factor statement;
depicting with said question said factor array to said audience with a visual decision board, having a distinct first preference portion and a distinct second preference portion, with a visual indicator visually proximate to said board depicting a first visual representation as a function of said weighted factors;
presenting a factor array modification field to said audience for composing a proposed modification of said factor array including at least a weight indicator adjuster, corresponding to at least one of said factor statements;
altering said factor array based on said proposed modification to create an updated factor array; and
updating said visual indicator to a second visual representation according to said function based upon said updated factor array.

2. The process of claim 1 wherein said displaying step includes displaying a polar question.

3. The process of claim 2 wherein said presenting step includes presenting a said factor array modification field with a factor statement entry field for the freestyle entry of a proposed factor statement and said weight indicator adjustor corresponding to said proposed factor statement.

4. The process of claim 1 wherein said presenting step includes presenting said factor array modification field with a factor statement entry field for the freestyle entry of a proposed factor statement and said weight indicator adjustor corresponding to said proposed factor statement.

5. The process of claim 4 wherein said presenting step includes presenting said factor array modification field with said factor statement field with a corresponding field weight indicator adjustor.

6. The process of claim 1 further comprising an exhibiting step that includes exhibiting to said audience proposed modifications to said factor array.

7. The process of claim 5 wherein said exhibiting step includes exhibiting to said audience proposed modifications including factor statement additions to said factor array modification field.

8. The process of claim 7 wherein said exhibiting step includes exhibiting to said audience proposed modifications including weighted factor statement additions to said factor array modification field.

9. The process of claim 1 further including the step of notifying said inquirer in response to said proposed modification.

10. The process of claim 1 further comprising the step of publishing a decision to said audience.

11. The process of claim 10 further comprising the step of communicating to said audience via electronic, private communication said decision.

12. The process of claim 1 further comprising the step of temporally restricting said proposed modifications.

13. The process of claim 1 further comprising the step of: electing at least one topical category; and alerting said audience to at least one question related to said topical category.

14. The process of claim 1 further comprising the step of storing an audience list demarcated by topical category.

15. A multiple party decision process comprising:
displaying an electronically-posted two-answer question viewable by a inquirer-selected audience;
defining through said inquirer a modifiable factor array composed of factor statements, related to said question, bearing a preference identifier relating to one of two user-defined preferences and a modifiable weight, displayed in a weight indicator, corresponding to each factor statement;
depicting with said question said factor array to said audience with a visual decision board, having a distinct first preference portion for placement of single-concept preference statements and a distinct second preference portion for placement of single-concept preference statements, with a visual indicator depicting a first visual representation as a function of said weighted factors;
presenting a factor array modification field to said audience for composing a proposed modification to said factor array;
modifying said factor array based on said proposed modification of said factor array to create an updated factor array; and
updating said visual indicator to a second visual representation according to said function based upon said updated factor array.

16. The process of claim 15 wherein said modifying step includes presenting said factor array modification field with a factor statement field for the freestyle entry of a proposed factor statement.

17. The process of claim 16 wherein said modifying step includes presenting said factor array modification field with said factor statement field and a corresponding field weight indicator adjustor.

18. The process of claim 15 wherein said two-answer question is a polar question.

19. The process of claim 16 wherein said defining step includes defining through said inquirer said modifiable factor array composed of modifiable factor statements selected from a group consisting of single-concept benefit statements, single-concept detriment statements, and combinations thereof.

20. A multiple party decision system comprising:
a polar question display adapted to display an electronically-posted polar question viewable by an inquirer-selected audience;
a factor array composed of modifiable factor statements, related to said question, and selected from a group consisting of single-concept benefit statements, single-concept detriment statements, and combinations thereof,
a modifiable weight, displayed in a weight indicator, corresponding to each factor statement;
a decision depiction bearing said question and said factor array to said public audience with a visual decision board, having a distinct positive portion for placement of single-concept benefit statements and a distinct negative portion for placement of single-concept detriment statements, with a visual indicator depicting a first visual representation as a function of said weighted factors;
a factor array modification field for audience composition of a proposed modification of said factor array including at least a weight indicator adjuster, corresponding to each of said factor statements;
an array modifier for modifying said factor array based on said proposed modification of said factor array to create an updated factor array; and
an array updater for updating said visual indicator to a second visual representation according to said function based upon said updated factor array.
